(19) United States
(12) Patent Application Publication
(10) Pub. No.: US 2021/0001655 A1
(43) Pub. Date: Jan. 7, 2021

(54) CONTAINER, METHOD FOR MANUFACTURING CONTAINER, AND PRINTING APPARATUS

(71) Applicant: DAIWA CAN COMPANY, Tokyo (JP)

(72) Inventors: Eiji Fujishige, Sagamihara-shi (JP); Hiroyuki Ohno, Sagamihara-shi (JP); Makoto Hasegawa, Mohka-shi (JP)

(73) Assignee: DAIWA CAN COMPANY, Tokyo (JP)

(21) Appl. No.: 17/029,938

(22) Filed: Sep. 23, 2020

Related U.S. Application Data
(63) Continuation of application No. PCT/JP2019/013497, filed on Mar. 28, 2019.

(30) Foreign Application Priority Data
Mar. 28, 2018 (JP) 2018-061803

(51) Int. Cl. B41M 1/18; B41M 1/40; B41F 17/22; B65D 25/34; B41M 1/28

(52) U.S. Cl. CPC B41M 1/18; B41M 1/40; B41M 1/28; B65D 25/34; B41F 17/22

(57) ABSTRACT

A container includes a body; a first printing layer provided on an outer surface of the body and including a first printing section including a first set of halftone dots or a first solid; and a second printing layer provided on an outer surface of the body to overlap at least a printing area of the first printing layer, including a second set of halftone dots with a dot percentage equal to or greater than a dot percentage of the first set of halftone dots or a second solid, and having a printing area larger than the printing area of the first printing section.

### CROSS-REFERENCE TO RELATED APPLICATIONS

This is a Continuation Application of PCT application No. PCT/JP2019/013497, filed Mar. 28, 2019, which was published under PCT Article 21(2) in Japanese.

This application is based upon and claims the benefit of priority from Japanese Patent Application No. 2018-061803, filed Mar. 28, 2018, the entire contents of which are incorporated herein by reference.

### BACKGROUND

### Field

The present invention relates generally to a printed container, a method of manufacturing the container, and a printing apparatus.

### Description of the Related Art

Conventionally, a technique of printing a design or the like on a body of a beverage can or a resin container has been known. As such a printing method, as disclosed in Jpn. Pat. Appln. KOKAI Publication No. H10-35077, the technique of supplying a plurality of types of liquid inks respectively to a plurality of plate cylinders, transferring the inks to a blanket with the plate cylinders, rotating a container on the blanket, transferring the inks to the container, and then drying the inks is known.

However, when a plurality of types of inks are printed simultaneously, the inks are mixed at boundaries; thus, in order to prevent different inks from mixing with each other, the printing is performed by providing a gap between the areas to which different inks are applied.

Further, as disclosed in Jpn. Pat. Appln. KOKAI Publication No. H5-96704, the technique of transferring inks to respective blankets, printing an ink on a can body with each blanket sequentially, and thereby printing inks in an overlapping manner while preventing the inks from mixing with each other, are known.

### BRIEF SUMMARY OF THE INVENTION

However, if a gap is provided between areas to which different inks are applied, the design may deteriorate. In recent years, from the standpoint of product sales, importance has been placed on the product design applied to containers, and excellently decorated containers have been required.

On the other hand, when liquid inks are printed in an overlapping manner through repeat printing and drying, the number of printing processes increases, and this leads to the problem of poor productivity.

Accordingly, an object of the present invention is to provide a container with both excellent decoration and high productivity, even when a plurality of liquid inks are printed in an overlapping manner; a method of manufacturing the container, and a printing apparatus.

According to one aspect of the present invention, a container includes a body; a first printing layer provided on an outer surface of the body and including a first printing section including a first set of halftone dots or a first solid; and a second printing layer provided on an outer surface of the body to overlap at least a printing area of the first printing layer, including a second set of halftone dots with a dot percentage equal to or greater than a dot percentage of the first set of halftone dots or a second solid, and having a printing area larger than the printing area of the first printing section.

According to one aspect of the present invention, a method of manufacturing a container includes supplying a liquid ink, from a first ink supply device, to a first convex section of a first plate cylinder, which transfers a first printing section including at least a first set of halftone dots or a first solid; transferring a first printing layer to a blanket using the ink supplied to the first convex section, with the first convex section brought into contact with the blanket; supplying liquid ink, from a second ink supplying device to a second convex section of a second plate cylinder of a printing area larger than the first printing section, for transferring a second halftone dot having a dot percentage equal to or greater than a dot percentage of the first halftone dot at least to overlap at least the printing area of the first plate cylinder or a second solid; transferring a second printing layer to a blanket by using the ink supplied to the second convex section, with the second convex section brought into contact with a printing area to which the ink has been transferred by the first convex section on the blanket to which the ink supplied to the first convex section has been transferred; and; printing the ink on the body with the blanket, to which the ink supplied to the first convex section and the second convex section has been transferred, being brought into contact with an outer surface of the body of the container.

According to one aspect of the present invention, a printing apparatus includes a first plate cylinder including a first convex section configured to transfer a first printing section including at least a first set of halftone dots or a first solid; a first ink supply device configured to supply a liquid ink to the first convex section; a second plate cylinder provided on a secondary side of the first plate cylinder and including a second convex section having a printing area larger than the first printing section, and configured to transfer a second set of halftone dots with a dot percentage equal to or greater than a dot percentage of the first set of halftone dots to overlap at least a printing area of the first plate cylinder or a second solid; a second ink supply device configured to supply a liquid ink to the second convex section; and a blanket to which the ink is transferred from the first convex section and the second convex section in the order of the first plate cylinder and the second plate cylinder, the blanket configured to print the transferred ink on an outer surface of the body of the container.

According to the present invention, it is possible to provide a container with excellent decoration and high productivity even when a plurality of liquid inks are printed in an overlapping manner; a method of manufacturing the container, and a printing apparatus.

### BRIEF DESCRIPTION OF THE DRAWINGS

FIG. 1 is a side view schematically showing a configuration of a can body according to an embodiment of the present invention.

FIG. 2 is an explanatory view schematically showing a configuration of a can body printing apparatus according to an embodiment of the present invention.

FIG. 3 is a developed plan view of a first plate cylinder used in the printing apparatus.

FIG. 4 is a cross-sectional view showing the configuration of the first plate cylinder.

FIG. 5 is a developed plan view of a second plate cylinder used in the printing apparatus.

FIG. 6 is a cross-sectional view showing a configuration of the second plate cylinder.

FIG. 7 is a flowchart showing, by a plan view, an example of a method of manufacturing a can body using the printing apparatus.

FIG. 8 is a flow chart showing, by a cross-sectional view, an example of the method of manufacturing a can body using the printing apparatus.

### DETAILED DESCRIPTION

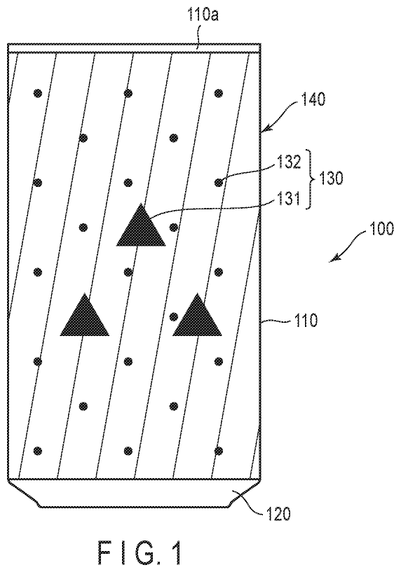

Hereinafter, a configuration of a can body 100, a method of manufacturing the can body 100, and a configuration of a printing apparatus 1 according to an embodiment of the present invention will be described with reference to FIGS. 1 to 8.

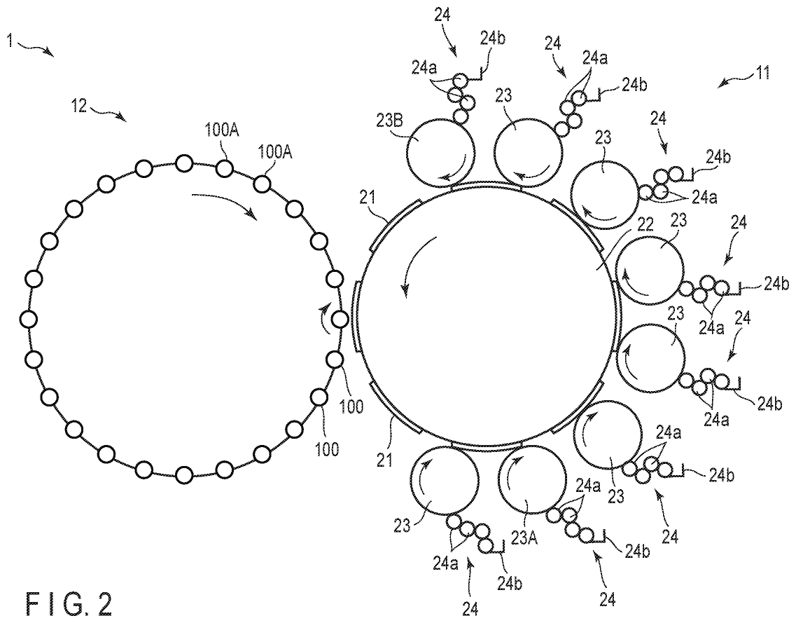

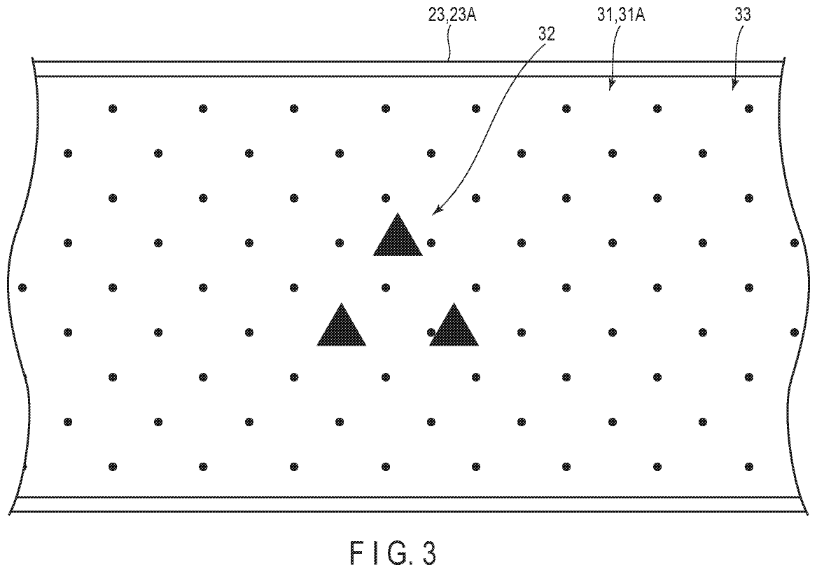

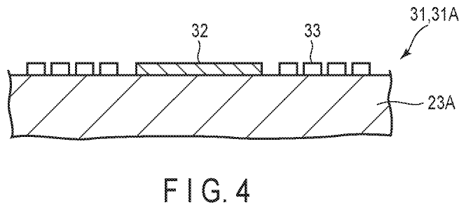

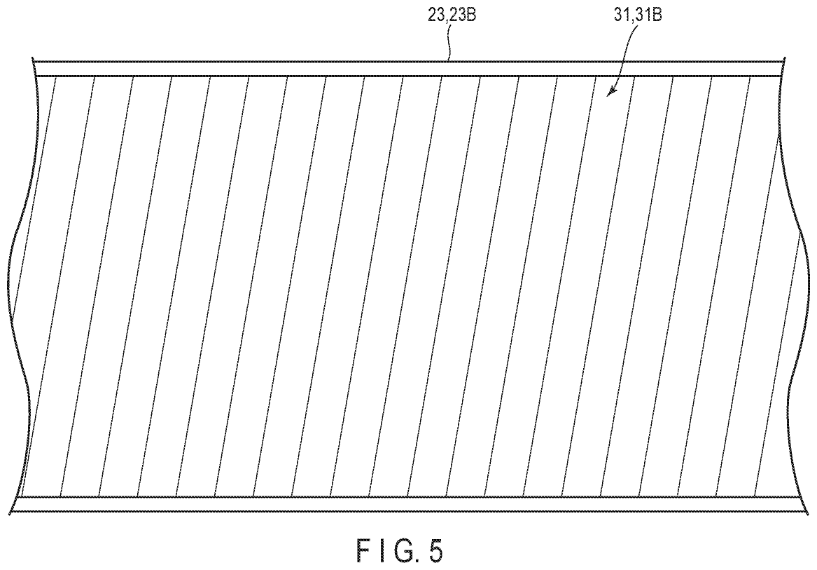

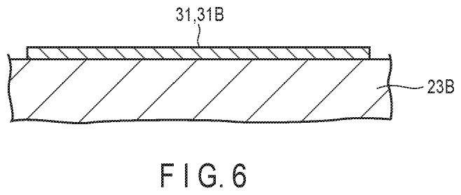

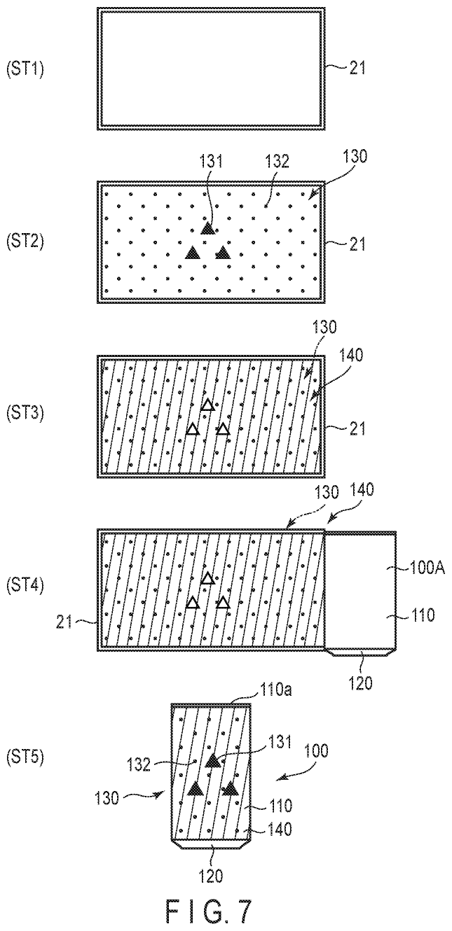

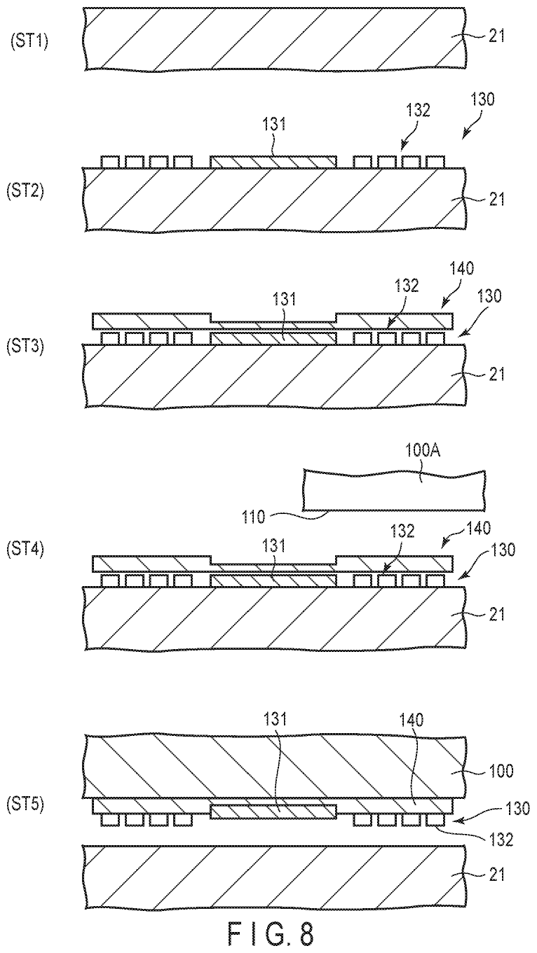

FIG. 1 is a side view schematically showing a configuration of a can body 100 according to an embodiment of the present invention. FIG. 2 is an explanatory view schematically showing a configuration of a printing apparatus 1 which performs printing on a can body 100 according to an embodiment of the present invention. FIGS. 3 and 4 are a developed plan view and a cross-sectional view, each showing the configuration of a first plate cylinder 23A used in the printing apparatus 1, and FIGS. 5 and 6 are a developed plan view and a cross-sectional view, each showing the configuration of a second plate cylinder 23B used in the printing apparatus 1. FIGS. 7 and 8 are flowcharts showing, by a plan view and a cross-sectional view, an example of a method of manufacturing the can body 100 using the printing apparatus 1.

First, the configuration of the can body 100 will be described with reference to FIG. 1. In the present embodiment, a can body 100 formed by a metal material is used as the container; however, the container is not limited to the can body 100, and may be another type of container such as a cup, etc. formed by a resin material. That is, any container can be used as appropriate providing printing can be applied to the outer surface of the container.

As shown in FIG. 1, the can body 100 includes, for example, a cylindrical body 110, and a bottom 120 formed integrally with the body 110 at one end of the body 110, and has an opening 110a to which a lid is attached at the other end of the body 110.

The can body 100 is formed by drawing with ironing a metal plate such as an aluminum alloy or a surface-treated steel plate into a bottomed cylindrical shape.

The outer surface of the body 110 is decorated by printing. Specifically, the body 110 includes a first printing layer 130 printed on the outer surface side and a second printing layer 140 printed between the outer surface of the body 110 and the first printing layer 130.

The first printing layer 130 is printed on the outer surface of the second printing layer 140. The first printing layer 130 includes a first printing section 131, and preferably further includes a second printing section 132. The first printing layer 130 has a section where printing is not performed in a part of the printing area. That is, the printing area of the first printing layer 130 is an area in which a blanket 21, to be described later, of the printing apparatus 1 faces the body 110, and includes a range in which an ink is applied and an area in which an ink is not applied. In the first printing layer 130, the first printing section 131 and the second printing section 132 are formed of the same ink, that is, ink of the same color.

The first printing section 131 is constituted by at least one of a set of halftone dots (first set of halftone dots) with a dot percentage of 80% or more, and a solid (first solid). The first printing section 131 constitutes a part of the printing area of the first printing layer 130.

Here, the term “set of halftone dots” refers to so-called “halftone dot printing” provided by printing a plurality of dots in a printing area. For this reason, the printing area of the set of halftone dots exhibits a gap between adjacent dots. Further, the dot percentage of the set of halftone dots is a total area of a plurality of dots with respect to a printing area in which the dots are printed, and is obtained by A0=A1/A×100, where the dot percentage is A0(%), the total area of the printing area is A (mm²) and the total area of the plurality of dots is A1 (mm²). Also, the term “solid” refers to an area over the entirety of which an ink is printed, i.e., a printing area entirely filled with an ink; so-called “solid printing”.

In the present embodiment, the first printing section 131 having three triangular solids as shown in black in FIG. 1 is described.

The second printing section 132 includes a set of halftone dots having a lower dot percentage than the first set of halftone dots of the first printing section 131, preferably, a set of halftone dots having a dot percentage of 10% or less. In the present embodiment, the second printing section 132 having a plurality of circular points as shown in FIG. 1 is described.

The second printing layer 140 includes at least one of a set of halftone dots (second set of halftone dots) with a dot percentage of 80% or more, and a solid (second solid). The second printing layer 140 is formed in an area substantially equal to or greater that of the first printing layer 130 and larger than that of the first printing section 131. More preferably, the printing area of the second printing layer 140 is set to 90% to 110% of that of the first printing layer 130. The second printing layer 140 is preferably constituted by one of a set of halftone dots having a dot percentage of 80% or more, and a solid.

The second printing layer 140 is formed of an ink different from that of the first printing layer 130, that is, an ink of a different color to that of the first printing layer 130.

The second printing layer 140 preferably has a lower brightness than the first printing layer 130. In other words, the ink used for the second printing layer 140 has a lower brightness than the ink used for the first printing layer 130. For example, the ink used for the second printing layer 140 is of an achromatic color such as black or gray, or low-brightness (dark) green, navy, red, etc., and is preferably black.

In the present embodiment, as shown by diagonal lines in FIG. 1, the second printing layer 140 is a solid provided on the entire circumferential area of the body 110.

Next, the printing apparatus 1, which applies printing including the first printing layer 130 and the second printing layer 140 on the body 110 of the can body 100, will be described with reference to FIGS. 2 to 6.

The printing apparatus 1 is a multicolor printing apparatus for manufacturing the can body 110 by printing a predetermined design on the unprinted body 110 of the can body 100A with a plurality of types of liquid inks, i.e., liquid inks of different colors. As shown in FIG. 2, the printing apparatus 1 includes a printing apparatus main body 11 and a can body supply device 12. As the liquid inks used in the present embodiment, inks for offset printing, etc. having fluidity and relatively high viscosity can be suitably used.

The printing apparatus main body 11 includes a plurality of blankets 21, a blanket transport device 22 which moves the blankets 21 along a predetermined transport path, a plurality of plate cylinders 23, and a plurality of ink supply devices 24 respectively provided on the plate cylinders 23.

Liquid inks are sequentially transferred from the plate cylinders 23 to the surface of each blanket 21. The blanket 21 abuts the body 110 of the can body 100A and is rotated to print on the body part 110. The blanket 21 is formed, e.g., in a rectangular shape. The blanket 21 is, for example, a rubber blanket formed of a rubber material.

The blanket transport device 22 has a cylindrical shape. The blanket transport device 22 has a drive mechanism that rotates in one direction. A plurality of blankets 21 are arranged at equal intervals on the outer peripheral surface of the blanket transport device 22. The blanket transport device 22 transports the blankets 21 on a circular transport path.

Specifically, the blanket transport device 22 transports the blankets 21 on a transport path that brings the blankets 21 in contact with the plate cylinders 23, consecutively, from those on a primary side to those on a secondary side and then with the body 110 after the contact with the plate cylinders 23 on the secondary side, and brings once again into contact with the plate cylinders 23 on the primary side. Here, the “primary side” refers to a part of the transport path after printing on the body 110 of the can body 100A, and the “secondary side” refers to a part of the transport path to apply printing on the body 110 in a transport direction of the transport path of the blankets 21.

The plate cylinder 23 is a cylindrical relief plate that transfers ink to each blanket 21. A plurality of plate cylinders 23 are arranged on the transport path of the blanket transport device 22. Each of the plate cylinders 23 is provided with a drive mechanism for rotating the plate cylinder 23 in one direction.

The plate cylinders 23 are arranged on the transport path such that the brightness of the ink supplied by the ink supply device 24 gradually decreases from the primary side toward the secondary side. Each of the plate cylinders 23 has a convex section 31 to which ink is supplied.

The plate cylinders 23 include a first plate cylinder 23A for transferring the first printing layer 130 to the blanket 21 and a second plate cylinder 23B for transferring the second printing layer 140 to the blanket 21.

Here, the arrangement of the plate cylinders 23 does not require the first plate cylinder 23A and the second plate cylinder 23B to be arranged side by side. In this embodiment, the second plate cylinder 23 from the primary side to the secondary side is referred to as the “first plate cylinder 23A”, and the last plate cylinder 23 from the primary side to the secondary side is referred to as the “second plate cylinder 23B”. In the following description, the convex section 31 of the first plate cylinder 23A is referred to as a “first convex section 31A”, and the convex section 31 of the second plate cylinder 23B is referred to as a “second convex section 31B”.

The first convex section 31A of the first plate cylinder 23A includes a first convex group 32 formed in the same shape as the first print section 131 and a second convex group 33 formed in the same shape as the second print section 132. In the present embodiment, the first convex group 32 is constituted by three projections having a triangular shape in plan view, in other words, three triangular prism projections. The second convex group 33 is constituted by a plurality of projections having a circular shape in plan view, in other words, a plurality of cylindrical projections. In the present embodiment, the first convex section 31A is described as including the convex groups 32 and 33; however, since the configuration of the first convex section 31A depends on the shapes of the first printing section 131 and the second printing section 132, it is apparent that the first convex section 31A may be configured by a single projection instead of a combination of the convex groups.

The second convex section 31B of the second plate cylinder 23B is a single rectangular projection having substantially the same area as that of the first convex section 31A of the first plate cylinder 23A. In the present embodiment, since the second printing layer 140 is a second solid, the second convex section 31B is a single rectangular projection; however, since the configuration of the second convex section 31B depends on the shape of the second printing layer 140, for example when the second printing layer 140 is constituted by the second set of halftone dots, the second convex section 31B may be a convex group formed of a plurality of cylindrical projections.

That is, the second convex section 31B may be a single projection, a convex group including a plurality of projections, or a combination thereof as long as the printing area of one second convex section 31B is larger than the printing area of the projection (first convex group 32) that prints the first printing section 131 of the first convex section 31A and is substantially equal to or greater than the printing area of the first printing layer 130 (first convex section 31A).

The first convex section 31A and the second convex section 31B need only transfer an ink having the shape of the first set of halftone dots or the first solid of the first printing layer 130 and an ink having the shape of the second set of halftone dots or the second solid of the second printing layer 140 to a blanket 21, and apply printing to the body 110 by the blanket 21. That is, regarding the relationship between the shape of the convex section 31 of the plate cylinder 23 and the printing shape of the ink printed on the body 110 via the blanket 21, the printing shape is slightly expanded from the shape of the convex section 31 in accordance with the properties of the ink when the ink is transferred to the blanket 21 and when the ink is printed on the body 110 from the blanket 21 in the transfer and printing processes. For this reason, the dot percentage of each set of halftone dots may be managed by any of the shapes of the first printing layer 130 and the second printing layer 140 printed on the body 110, and the convex section 31, but it is preferable to manage the dot percentage by the shape of the convex section 31 in consideration of variations caused during printing.

The plate cylinders 23 configured as described above transfer a plurality of inks onto the blanket 21 by the convex sections 31 of the respective plate cylinders 23. The first plate cylinder 23A and the second plate cylinder 23B transfer inks onto the blanket 21 in the order of the first printing layer 130 and the second printing layer 140.

The ink supply device 24 includes, for example, a plurality of rollers 24a and an ink supply section 24b, such as a pallet or a tank. In addition, the ink supply device 24 includes a driving mechanism that rotates each of the rollers 24a in one direction. The ink supply device 24 supplies the ink supplied to the ink supply section 24b from a primary side roller 24a adjacent to the ink supply section 24b to a secondary side roller 24a adjacent to the plate cylinder 23, through a roller 24a at an intermediate position, and supplies the ink from the secondary side roller 24a to the convex section 31 of the plate cylinder 23. The ink not supplied from the secondary side roller 24a to the convex section 31 is returned to the roller 24a at the intermediate position and supplied again to the secondary side roller 24a.

A can body supply device 12 moves a plurality of can bodies 100A in one direction along a circular transport path so that they abut on a blanket 21, and rotates the can bodies 100A when the can bodies 100A abut on the blanket 21. For example, the can body supply device 12 includes a plurality of mandrels that rotatably hold the can bodies 100 and 100A, transports the mandrels in the transport direction of the can bodies 100 and 100A, and rotates the mandrels in a range facing the blanket 21, thereby rotating the can bodies 100A held by the mandrels in a state of abutting on the blanket 21. The can body supply device 12 includes a collection section for collecting the printed can body 100 and supply means for supplying the unprinted can body 100A to the can body supply device 12.

Next, a method of manufacturing the can body 100 using the printing apparatus 1 configured as described above will be described with reference to FIGS. 7 and 8. The ink transfer by the first plate cylinder 23A and the second plate cylinder 23B will be described below, and the explanation of ink transfer by the other plate cylinders 23 will be omitted.

First, the printing apparatus 1 supplies ink that can be printed on a predetermined number of can bodies 100A to the ink supply section 24b of each ink supply device 24. A predetermined amount of ink is supplied each time printing is performed on a number of can bodies 100A slightly smaller than the predetermined number.

Next, the printing apparatus 1 moves a blanket 21 from the primary side along the transport path through the blanket transport device 22 (step ST1). When the blanket 21 is moved to the first plate cylinder 23A by the blanket transport device 22, the printing apparatus 1 transfers the first printing layer 130 onto the blanket 21 through the first convex section 31A of the first plate cylinder 23A (step ST2).

Next, when the blanket 21 is moved to the second plate cylinder 23B by the blanket transport device 22, the printing apparatus 1 transfers the second printing layer 140 onto the first printing layer 130 of the blanket 21 through the second convex section 31B of the second plate cylinder 23B (step ST3).

At this time, the ink transferred by the first plate cylinder 23A has not been dried and remains in a liquid state, and the second printing layer 140 constituted by the liquid ink is transferred onto the first printing layer 130 constituted by the liquid ink.

As a result, as shown in step ST3 of FIG. 8, of the second printing layer, the amount of ink transferred to an area to which the first printing section 131 has been transferred is smaller than both the amount transferred to an area to which the second printing section 132 has been transferred, and the amount transferred to an area to which no ink of the first printing layer 130 has been transferred.

Specifically, liquid inks have the characteristic of not sufficiently sticking (adhering) to another liquid ink transferred as a high-density set of halftone dots, such as a set of halftone dots with a dot percentage of 80% or more Or as a solid. In addition, liquid inks have the characteristic of sufficiently sticking (adhering) to the surface of the body 110 in a case either where there is a sufficient gap between portions printed by another liquid ink, for example, between adjacent dots of the set of halftone dots, or where another liquid ink has not been transferred. Here, the “sufficient gap” refers to, for example, a case where the dot percentage of the set of halftone dots of the first printing layer 130 is lower than 80%, but differs depending on the characteristics of the ink used.

Due to such characteristics of liquid inks, in the second printing layer 140, the amount of ink transferred onto the first printing section 131 in which the ink is densely provided is smaller than that transferred onto the second printing section 132.

Next, the printing apparatus 1 moves the blanket 21 through the blanket transport device 22 to a position facing the can body 100A supplied by the can body supply device 12 (step ST4). Further, the blanket 21 is moved by the blanket transport device 22, and the can body 100A is moved and rotated by the can body supply device 12, whereby the first printing layer 130 and the second printing layer 140 on the blanket 21 are printed on the body 110 (step ST5). At this time, as shown in step ST5 of FIG. 8, the second printing layer 140 is printed on the outer surface of the body 110, and the first printing layer 130 is printed on the second printing layer 140. By repeating these steps, the can body 100 on which printing is performed is manufactured.

According to the can body 100, the printing apparatus 1, and the method of manufacturing the can body 100 configured as described above, by transferring the second printing layer 140 having a larger printing area than the first printing section 131 onto the first printing section 131 of the first printing layer 130 transferred to the blanket 21, the amount of ink transferred to the first printing section 131 can be made smaller than that transferred to the area other than the first printing section 131 of the first printing layer 130.

That is, the amount of ink of the second printing layer 140 applied on the first printing section 131 of the first printing layer 130 is smaller than that of the second printing layer 140 applied on the area other than the first printing section 131 of the first printing layer 130, which is the second printing section 132 in the present embodiment. As a result, the color of the second printing layer 140 on the first printing section 131 is lighter than that of the second printing layer 140 on the second printing section 132, and even if the second printing layer 140 is provided in the printing area of the first printing layer 130, the brightness can be varied between the areas where the first printing section 131 and second printing section 132 are provided.

When the first printing layer 130 and the second printing layer 140 on the blanket 21 are transferred to the body 110 of the can body 100A, the first printing layer 130 is provided on the outer surface of the second printing layer 140; however, since the brightness of the first printing layer 130 is higher than that of the second printing layer, the color of the second printing layer 140 is seen through the first printing section 131 of the first printing layer 130 and the second printing section 132. At this time, since the amount of ink of the second printing layer 140 stacked on the first printing section 131 is smaller than that of the second printing layer 140 stacked on the second printing section 132, the color tone of the area where the first printing section 131 is provided is relatively brighter than that of the area where the second printing section 132 is provided.

As a result, it is possible to provide a change in color between the area where the first printing section 131 of the can body 100 is provided and the area where the second printing section 132 is provided, and it is possible to improve decoration, since there is no area to which ink is not applied between designs. In addition, since the amount of ink in the second printing layer 140 in the area where the first printing section 131 is provided can be rendered smaller than that in the second printing layer 140 in the other area, for example, in a case where a base such as a metallic gloss, white, or another color is provided on the surface of the body 110, the base of the body 110 becomes transparent and can thus be used for decorative purposes.

In addition, according to the printing apparatus 1 and the method of manufacturing the can body 100, even in a case where different liquid inks are used, it is not necessary to repeatedly perform the printing and drying processes, such as applying an ink to the can body 100, drying the ink, and additionally applying an ink to the can body 100. For this reason, the printing apparatus 1 and the method for manufacturing the can body 100 do not increase the number of manufacturing steps, and thus exhibit high productivity even when the decoration of the can body 100 is improved.

Further, by making the printing area of the first printing layer 130 on which the first print section 131 is printed smaller than that of the second printing layer 140, the amount of ink remaining on the second convex section 31B of the second plate cylinder 23B can be minimized. In the printing apparatus 1, the second plate cylinder 23B, which uses ink of low brightness, is arranged on the secondary side of the first plate cylinder 23A.

Thus, when an ink is transferred again by the first plate cylinder 23A to the blanket 21 after printing on the can body 100, reverse transfer of the ink printed by the second plate cylinder 23B and remaining on the blanket 21 to the first convex section 31A of the first plate cylinder 23A can be minimized.

The printing area of the second printing layer 140 is set to 90% to 110% of the printing area of the first printing layer 130. Therefore, even if the ink transferred by the second plate cylinder 23B and remaining on the blanket 21 is reverse transferred to the first convex section 31A of the first plate cylinder 23A, the amount of the ink constituting the first printing layer is not significantly different from that constituting the second printing layer. Therefore, even if the ink constituting the second printing layer is mixed with that constituting the first printing layer, the ink constituting the first printing layer is sufficiently present, thereby preventing the ink constituting the first printing layer from being excessively discolored by that constituting the second printing layer.

In addition, in the manufacturing method of the can body 100, by periodically supplying the ink to the ink supply device 24, even if the ink transferred from the second plate cylinder 23B is transferred to the first convex section 31A and returned to the ink supply device 24 that supplies the ink to the first plate cylinder 23A, supply of the ink from the roller 24a at the intermediate position to the secondary side roller 24a renders it possible to prevent the ink of the ink supply device 24 that supplies the ink to the first plate cylinder 23A from mixing with other ink beyond a certain amount.

As described above, according to the can body 100, the method of manufacturing the can body 100, and the printing apparatus 1 of the present embodiment, both high productivity and excellent decoration are obtained even when a plurality of liquid inks are printed in an overlapping manner.

The present invention is not limited to the above-described embodiment. In the above-described example, the configuration in which the first printing layer 130 includes the first printing section 131 configured by a solid printing and the second printing section 132 configured by a set of halftone dots has been described; however, the configuration is not limited thereto. The first printing layer 130 has only the first printing section 131 without the second printing section, or may be a first printing section 131 including the first set of halftone dots and the first solid. That is, the first printing layer 130 may have any configuration as long as the first printing layer 130 includes the first printing section 131 having a smaller area than the second printing layer 140, and the amount of ink of the second printing layer 140 transferred to the blanket 21 differs between the first printing section 131 of the first printing layer 130 and the other area.

In addition, described above is the configuration in which the ink of the first printing layer 130 and that of the second printing layer 140 are transferred to the blanket 21 by one first plate cylinder 23A and one second plate cylinder 23B, respectively; however, the present invention is not limited thereto. For example, it is possible to transfer the first printing layer 130 to the blanket 21 by two or more plate cylinders 23 using different inks, or transfer each of the first printing layer 130 and the second printing layer 140 by a plurality of plate cylinders 23 using different inks.

That is, the present invention is not limited to the above-described embodiments, and various modifications can be made without departing from the scope of the present invention. In addition, the embodiments may be appropriately combined and implemented, and in this case, combined effects are obtained. Further, various inventions are included in the above embodiments, and various inventions can be extracted by a combination selected from a plurality of disclosed constituent elements. For example, even if some constituent elements are deleted from all the constituent elements shown in the embodiments, when the problem can be solved and the effect can be obtained, the configuration from which the constituent elements are deleted can be extracted as an invention.

What is claimed is:

1. A container comprising:
a body;
a first printing layer provided on an outer surface of the body and including a first printing section including a first set of halftone dots or a first solid; and
a second printing layer provided on an outer surface of the body to overlap at least a printing area of the first printing layer, including a second set of halftone dots with a dot percentage equal to or greater than a dot percentage of the first set of halftone dots or a second solid, and having a printing area larger than the printing area of the first printing section.

2. The container according to claim 1, wherein a brightness of the second printing layer is lower than the brightness of the first printing layer.

3. The container according to claim 1, wherein the first printing layer and the second printing layer are printed using a liquid ink.

4. The container according to claim 2, wherein the first printing layer and the second printing layer are printed using a liquid ink.

5. A method for manufacturing a container, the method comprising:
supplying a liquid ink, from a first ink supply device, to a first convex section of a first plate cylinder which transfers a first printing section including at least a first set of halftone dots or a first solid;
transferring a first printing layer to a blanket using the ink supplied to the first convex section, by bringing the first convex section into contact with the blanket;
supplying liquid ink, from a second ink supplying device, to a second convex section of a second plate cylinder of a printing area larger than the first printing section, for transferring a second halftone dot having a dot percentage equal to or greater than a dot percentage of the first halftone dot to overlap at least the printing area of the first plate cylinder or a second solid;
transferring a second printing layer to a blanket by using the ink supplied to the second convex section, with the second convex section brought into contact with a printing area to which the ink has been transferred by the first convex section on the blanket to which the ink supplied to the first convex section has been transferred; and
printing the ink on the body with the blanket, to which the ink supplied to the first convex section and the second convex section has been transferred, being brought into contact with an outer surface of the body of the container.

6. The method for manufacturing a container according to claim 5, wherein a brightness of the second printing layer is lower than a brightness of the first printing layer.

7. A printing apparatus comprising:
a first plate cylinder including a first convex section configured to transfer a first printing section including at least a first set of halftone dots or a first solid;
a first ink supply device configured to supply a liquid ink to the first convex section;
a second plate cylinder provided on a secondary side of the first plate cylinder, and including a second convex section having a printing area larger than the first printing section, and configured to transfer a second set of halftone dots with a dot percentage equal to or greater than a dot percentage of the first set of halftone dots to overlap at least a printing area of the first plate cylinder or a second solid;
a second ink supply device configured to supply a liquid ink to the second convex portion; and
a blanket to which the ink is transferred from the first convex section and the second convex section in order of the first plate cylinder and the second plate cylinder, the blanket configured to print the transferred ink on an outer surface of the body of the container.

8. The printing apparatus according to claim 7, wherein a brightness of the ink supplied by the second ink supply device is lower than a brightness of the ink supplied by the first ink supply device.
